(19) United States
(12) Patent Application Publication
(10) Pub. No.: US 2024/0426338 A1
(43) Pub. Date: Dec. 26, 2024

(54) AIR FOIL THRUST BEARING

(71) Applicant: Hanon Systems, Daejeon (KR)

(72) Inventors: Gunwoong Park, Daejeon (KR); Hyun Chil Kim, Daejeon (KR); Kyu Sung Choi, Daejeon (KR); Jun Hyuk Park, Daejeon (KR); Yong Ha Chae, Daejeon (KR)

(21) Appl. No.: 18/703,561

(22) PCT Filed: Nov. 4, 2022
(86) PCT No.: PCT/KR2022/017221

§ 371 Date: Apr. 22, 2024

(30) Foreign Application Priority Data
Dec. 28, 2021 (KR) 10-2021-0189455

(51) Int. Cl. F16C 17/04

(52) U.S. Cl. CPC F16C 17/042; F16C 2360/00

(57) ABSTRACT

The present invention relates to an air foil thrust bearing including a bump foil and a top foil stacked at a position corresponding to the bump foil to cover the bump foil, in which an outer diameter of the top foil is larger than an outer diameter of the bump foil in a radial direction, and the bump foil and the top foil are formed and disposed so that a portion where pressure of an air film between a thrust runner and the top foil is high when a rotor rotates is consistent with a region in which the bump foil exists, such that friction in an outermost peripheral region of the top foil based on the radial direction is reduced, durability is improved, the pressure of the air is relatively uniformly dispersed, and a load supporting force is improved.

### TECHNICAL FIELD

The present invention relates to an air foil thrust bearing capable of being used to support an axial load applied to a rotary shaft of a rotor of an air compressor or the like that compresses air by rotating an impeller at high speed by using a rotational force of a motor and supply the compressed air.

### BACKGROUND ART

Thrust bearings are used for air compressors or the like to support axial loads. Among the thrust bearings, an air foil thrust bearing is mainly used to support an axial load of a rotary shaft that rotates at high speed.

FIGS. 1 and 2 are perspective views illustrating an air foil thrust bearing in the related art.

As illustrated, the air foil thrust bearing in the related art may include a base plate 60 having a circular plate shape having a hole formed through a center thereof, a plurality of bump foils 80 arranged on the base plate 60 and spaced apart from one another in a circumferential direction, and a plurality of top foils 90 respectively stacked on upper sides of the bump foils 80. Further, the plurality of bump foils 80 of the air foil thrust bearing is fixed onto the base plate 60 by spot welding, the top foils 90 are disposed on the bump foils 80, and the top foils 90 are fixed to the base plate 60 by spot welding.

When the air compressor or the like is mounted on the air foil thrust bearing and used, a large amount of frictional heat is generated between contact between a top foil of the air foil thrust bearing and a circular plate-shaped thrust runner that is coupled to a rotary shaft of a rotor and rotates together with the rotary shaft of the rotor.

At an outermost periphery of the top foil based on the radial direction of the air foil thrust bearing, air leaks radially outward because of a centrifugal force, a pressure of an air film decreases, which makes it impossible for the air film to sufficiently push the top foils and the bump foils. For this reason, friction occurs between the thrust runner and the top foil in an outermost peripheral region of the top foil.

For this reason, in the air foil thrust bearing in the related art, a relatively large amount of heat is generated in the outermost peripheral region of the top foil based on the radial direction, and a coating film, which is formed on an upper surface of the top foil to reduce friction, is damaged, which degrades durability and performance of the air foil thrust bearing.

### DOCUMENT OF RELATED ART

### Patent Document

KR 10-2018-0024895 A (Mar. 8, 2018)

### DISCLOSURE

### Technical Problem

The present invention has been made in an effort to solve the above-mentioned problem, and an object of the present invention is to provide an air foil thrust bearing, in which a bump foil and a top foil are formed and disposed so that a portion where a pressure of an air film is relatively high is consistent with a region in which the bump foil exists, which reduces friction in an outermost peripheral region of the top foil based on a radial direction and relatively uniformly disperses a pressure of air, thereby improving a load supporting force.

### Technical Solution

In order to achieve the above-mentioned object, the present invention provides an air foil thrust bearing including: a base plate; a bump foil having elastic bumps and stacked and coupled onto the base plate; and a top foil stacked at a position corresponding to the bump foil to cover the bump foil, the top foil being coupled to the base plate, in which an outer diameter of the top foil is larger than an outer diameter of the bump foil in a radial direction.

In addition, a cut-out portion, which is formed in a shape made by removing a partial region of the bump foil, may be formed at an outer diameter side of the bump foil.

In addition, an inner diameter of the top foil and an inner diameter of the bump foil may be consistent with each other in the radial direction.

In addition, no additional foil may be interposed between the bump foil and the top foil.

In addition, B may be within a range larger than 0% of A and equal to or smaller than 15% of A when A is ½ of a difference between an outer diameter of the bump foil.

An inner diameter of the bump foil and B is ½ of a difference between an outer diameter of the top foil and the outer diameter of the bump foil.

In addition, one circumferential end of each of the bump foil and the top foil may be fixed to the base plate, the other end of each of the bump foil and the top foil may be configured as a free end, the other end of the top foil may be longer than the other end of the bump foil in a circumferential direction, and C may be within a range larger than 0% of A and equal to or smaller than 15% of A when C is a difference in length between the other end of the top foil and the other end of the bump foil.

In addition, the bump foil may be provided as a plurality of bump foils, the top foil may be provided as a plurality of top foils, and the plurality of bump foils and the plurality of top foils may be arranged to be spaced apart from one another in a circumferential direction.

In addition, the bump foil may have a slit formed through two opposite surfaces of the bump foil in a thickness direction.

Further, an air foil thrust bearing may include: a bump foil plate in which a bump foil having elastic bumps is integrally coupled to a first connection part; and a top foil plate in which a top foil is integrally coupled to a second connection part, the top foil plate being stacked on the bump foil plate so that the top foil is disposed at a position corresponding to the bump foil, in which an outer diameter of the top foil is larger than an outer diameter of the bump foil in a radial direction.

In addition, a cut-out portion, which is formed in a shape made by removing a partial region of the bump foil, may be formed at an outer diameter side of the bump foil.

In addition, an inner diameter of the top foil and an inner diameter of the bump foil may be consistent with each other in the radial direction.

In addition, no additional foil may be interposed between the bump foil and the top foil.

In addition, B may be within a range larger than 0% of A and equal to or smaller than 15% of A when A is ½ of a difference between an outer diameter of the bump foil and an inner diameter of the bump foil and B is ½ of a difference between an outer diameter of the top foil and the outer diameter of the bump foil.

In addition, the bump foil may have one circumferential end connected to the first connection part, and the other end configured as a free end, the top foil may have one circumferential end connected to the second connection part, and the other end configured as a free end, the other end of the top foil may be longer than the other end of the bump foil in a circumferential direction, and C may be within a range larger than 0% of A and equal to or smaller than 15% of A when C is a difference in length between the other end of the top foil and the other end of the bump foil.

In addition, the bump foil may be provided as a plurality of bump foils, the top foil may be provided as a plurality of top foils, and the plurality of bump foils and the plurality of top foils may be arranged to be spaced apart from one another in a circumferential direction.

In addition, the bump foil may have a slit formed through two opposite surfaces of the bump foil in a thickness direction.

### Advantageous Effects

According to the air foil thrust bearing of the present invention, friction in the outermost peripheral region of the top foil based on the radial direction may be reduced, thereby improving the durability. Further, the pressure of the air may be relatively uniformly dispersed, thereby improving the load supporting force.

### DESCRIPTION OF DRAWINGS

FIGS. 1 and 2 are perspective views illustrating an air foil thrust bearing in the related art.

FIGS. 3 to 5 are an assembled perspective view, an exploded perspective view, and a top plan view illustrating an air foil thrust bearing according to a first embodiment of the present invention.

FIG. 6 is a partially enlarged view of FIG. 5.

FIGS. 7 and 8 are graphs illustrating performance and losses in accordance with an expansion ratio of an outer diameter of the air foil thrust bearing according to the present invention.

FIGS. 9 to 11 are an assembled perspective view, an exploded perspective view, and a top plan view illustrating an air foil thrust bearing according to a second embodiment of the present invention.

FIG. 12 is a partially enlarged view of FIG. 11.

FIGS. 13 and 14 are a conceptual view of a pressure distribution of air and a conceptual view illustrating a flow line (stream line) of air flowing between a top foil and a thrust runner when the thrust runner of the air foil thrust bearing according to the second embodiment of the present invention rotates.

FIG. 15 is a conceptual view illustrating a cross-section when the air foil thrust bearing in the related art is cut to be inclined in a rotation direction of a rotor radially outward with respect to a radial direction.

FIG. 16 is a conceptual view illustrating a cross-section when the air foil thrust bearing according to the present invention is cut to be inclined in a rotation direction of a rotor radially outward with respect to a radial direction.

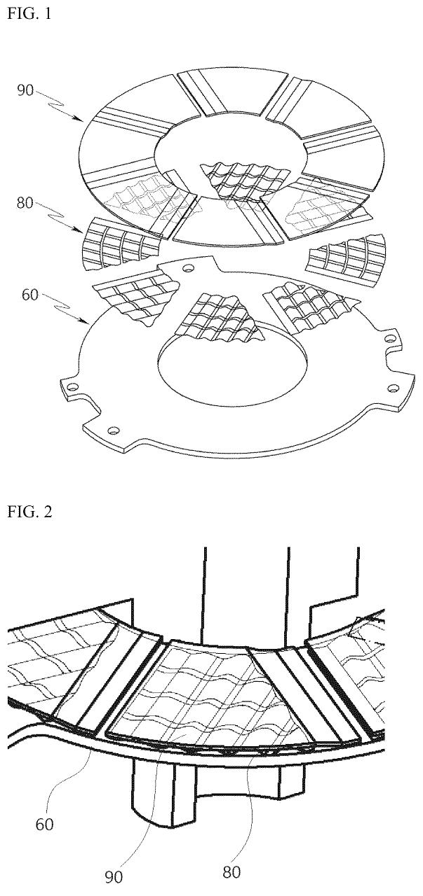

### MODE FOR INVENTION

Hereinafter, an air foil thrust bearing of the present invention configured as described above will be described in detail with reference to the accompanying drawings in detail.

### Embodiment 1

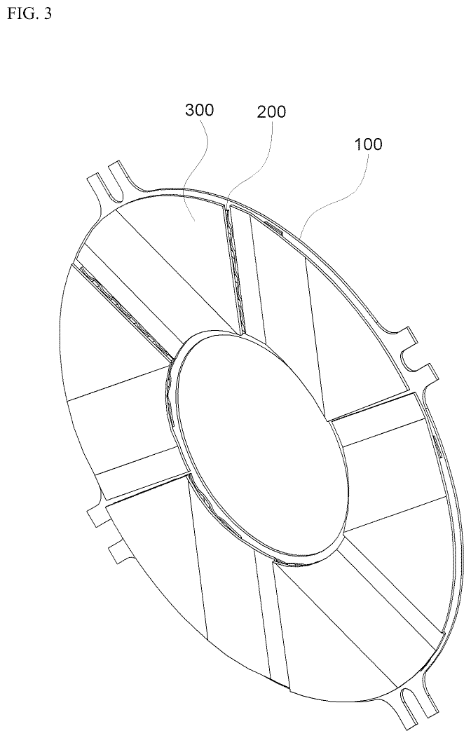

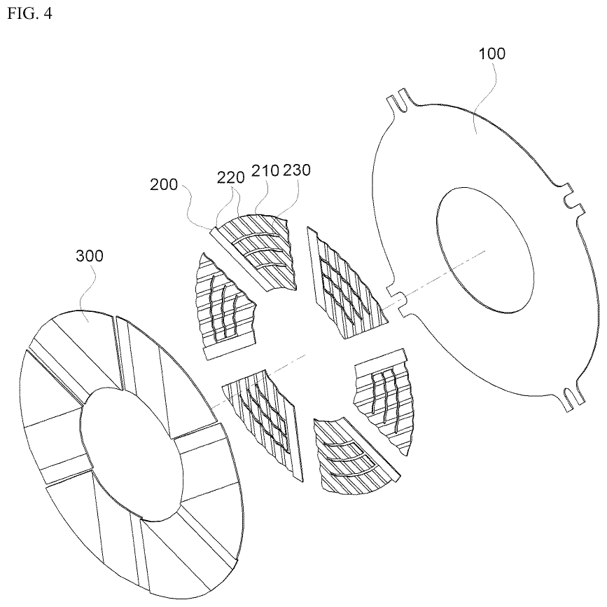

FIGS. 3 to 5 are an assembled perspective view, an exploded perspective view, and a top plan view illustrating an air foil thrust bearing according to a first embodiment of the present invention.

As illustrated, the air foil thrust bearing according to the first embodiment of the present invention may broadly include a base plate 100, bump foils 200, and top foils 300.

The base plate 100 may be formed in a circular plate shape having a hole provided at a center of the base plate 100 and formed through two opposite surfaces of the base plate 100 in a thickness direction.

The bump foils 200 may be provided as a plurality of bump foils 200 arranged on the base plate 100 and spaced apart from one another in a circumferential direction. Further, one circumferential end of each of the plurality of bump foils 200 may be fixedly coupled to the base plate 100 by spot welding or the like, and the other circumferential end of each of the plurality of bump foils 200 may be configured as a free end. Further, the plurality of bump foils 200 may each have elastic bumps 210 having a concave-convex shape. One side of the elastic bump 210 is in contact with and supported on the base plate 100. The elastic bump 210 may be separated from the base plate 100 without being fixed directly to the base plate 100. That is, the remaining portion of the bump foil 200, which excludes one circumferential end of the bump foil 200, may be spaced apart from the base plate 100 without being coupled to the base plate 100. The elastic bumps 210 may be stacked to be in contact with or slightly spaced apart from the base plate 100. In addition, slits 230 may be formed through the two opposite surfaces of the bump foil 200 in the thickness direction. The slit 230 may have various shapes. In addition, the elastic bumps 210 may be formed over a region from an inner end to an outer end of the bump foil 200 in the radial direction.

The top foils 300 may be provided as a plurality of top foils 300 arranged on the base plate 100 and spaced apart from one another in the circumferential direction. Further, one circumferential end of each of the top foils 300 may be fixedly coupled to the base plate 100 by spot welding or the like, and the other circumferential end of each of the top foils 300 may be configured as a free end. In addition, the top foil 300 may be disposed at a position corresponding to the bump foil 200 and stacked in a shape in which the top foil 300 covers the bump foil 200. That is, the bump foil 200 may be interposed between the base plate 100 and the top foil 300. In this case, an outer diameter of the top foil 300 may be larger than an outer diameter of the bump foil 200 in the radial direction. That is, the outer diameter of the bump foil 200 may be smaller than the outer diameter of the top foil 300. For example, an outer diameter side of the bump foil 200 may have a cut-out portion 220 formed in a shape made by removing a partial region of the bump foil 200. Therefore, the outer diameter side of the top foil 300 in the radial direction may have a shape extending over the outer diameter side of the bump foil 200. The outer diameter side of the top foil 300, which corresponds to an outer region of the cut-out portion 220 of the bump foil 200 in the radial direction, may not be supported by the elastic bump 210 of the bump foil 200.

Therefore, according to the air foil thrust bearing according to the first embodiment of the present invention, a pressure decreases as air, which flows between a rotating thrust runner and the top foil, leaks to the outside in the radial direction from the outer diameter side of the top foil. In this case, the air leaks at a position spaced apart radially outward from the region of the top foil supported by the elastic bump of the bump foil. Therefore, a portion where a pressure of an air film is high is consistent with a region in which the bump foil exists, such that friction in an outermost peripheral region of the top foil based on the radial direction is reduced, which may prevent the degradation of a coating layer applied onto a surface of the top foil, and as a result, the durability of the air foil thrust bearing may be improved. Further, the pressure of the air in the region supported by the bump foil is relatively uniformly dispersed, which may improve a load supporting force of the air foil thrust bearing.

In addition, in the air foil thrust bearing according to the first embodiment of the present invention, an inner diameter of the top foil 300 and an inner diameter of the bump foil 200 may be equal to each other in the radial direction. That is, when the inner diameter of the top foil 300 and the inner diameter of the bump foil 200 are equal to each other, the pressure of the air may be more uniformly dispersed in the region in which the top foil is supported by the bump foil, which may further improve the load supporting force of the air foil thrust bearing.

In addition, another foil may not be additionally interposed between the bump foil 200 and the top foil 300. That is, in case that another foil is interposed between the bump foil 200 and the top foil 300, the pressure of the air may not be uniformly dispersed, and the ability to support a load may deteriorate. Therefore, the air foil thrust bearing according to the first embodiment of the present invention is configured such that no foil is provided between the bump foil 200 and the top foil 300, which may prevent the deterioration in load supporting force.

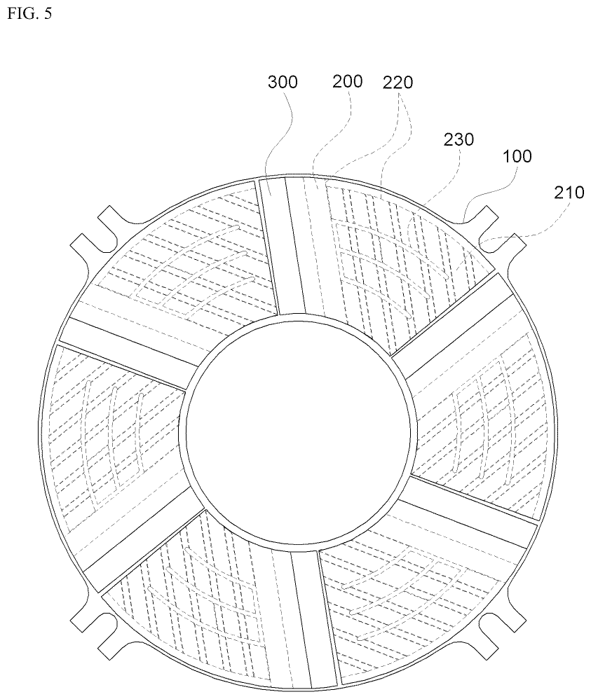

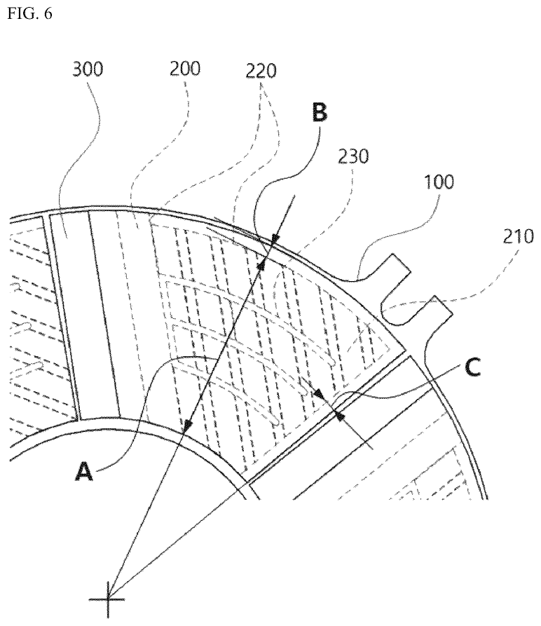

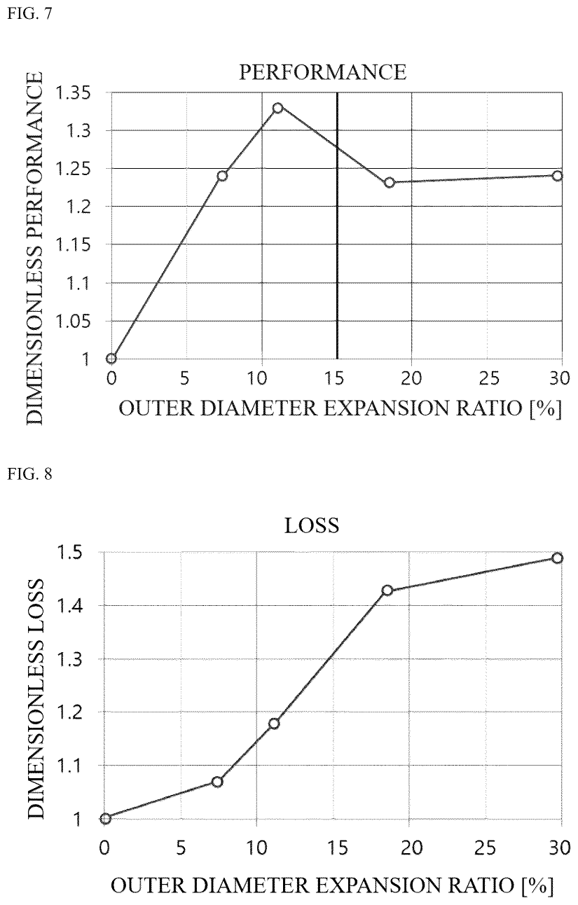

FIG. 6 is a partially enlarged view of FIG. 5, and FIGS. 7 and 8 are graphs illustrating performance and losses in accordance with an expansion ratio of an outer diameter of the air foil thrust bearing according to the present invention.

As illustrated, the air foil thrust bearing according to the first embodiment of the present invention may be formed such that B is within a range larger than 0% of A and equal to or smaller than 15% of A when A is ½ of a difference between the outer diameter of the bump foil 200 and the inner diameter of the bump foil 200 and B is ½ of a difference between the outer diameter of the top foil 300 and the outer diameter of the bump foil 200. In this case, when an outer diameter expansion ratio exceeds 15% when a ratio of B to A is defined as the outer diameter expansion ratio {(B/A)×100}, only the amount of loss increases without a further increase in performance.

This is because the outer diameter of the top foil 300 is excessively expanded, and a part of the expanded portion acts as an unnecessary area in which the pressure of the air film cannot be properly generated. Therefore, the radial lengths of the bump foil and the top foil need to be set within the above-mentioned range in order to obtain the effect of reducing a frictional loss of the top foil and improving the load supporting force.

In addition, the bump foil 200 and the top foil 300 may each have one circumferential end fixed to the base plate 100, and the other end configured as a free end, the other end of the top foil 300 may be longer than the other end of the bump foil 200 in the circumferential direction, and C may be within a range larger than 0% of A and equal to or smaller than 15% of A when C is a difference in length between the other end of the top foil 300 and the other end of the bump foil 200. Likewise, when the air leaks from the free end of the top foil 300 in the circumferential direction, the pressure of the air film decreases, which may cause friction between the top foil 300 and the thrust runner at the free end side of the top foil 300. Therefore, the lengths of the free end of the bump foil 200 and the free end of the top foil 300 in the circumferential direction are set within the above-mentioned range, which may obtain the effect of reducing friction of the top foil and improving the load supporting force.

In addition, the bump foils 200 may be provided as a plurality of bump foils 200, and the top foils 300 may be provided as a plurality of top foils 300. The plurality of bump foils 200 and the plurality of top foils 300 may be arranged to be spaced apart from one another in the circumferential direction. The number of bump foils 200, the number of top foils 300, and the intervals between the bump foils 200 and the top foils 300 spaced apart from one another may be variously defined.

### Embodiment 2

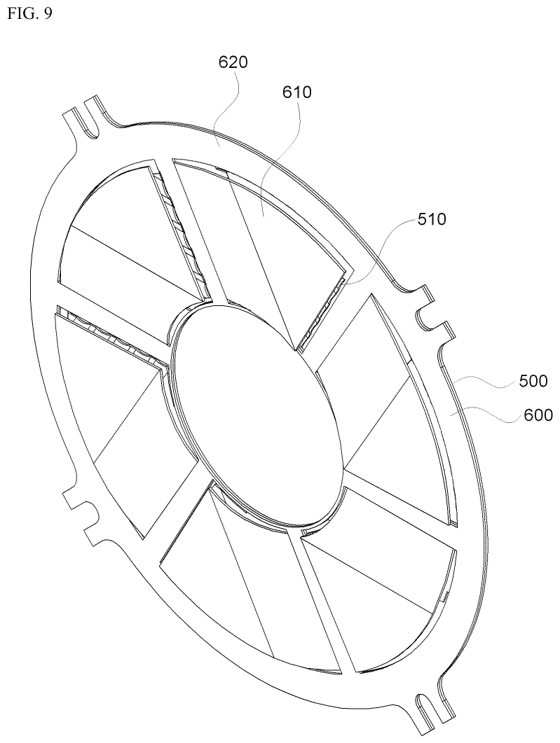

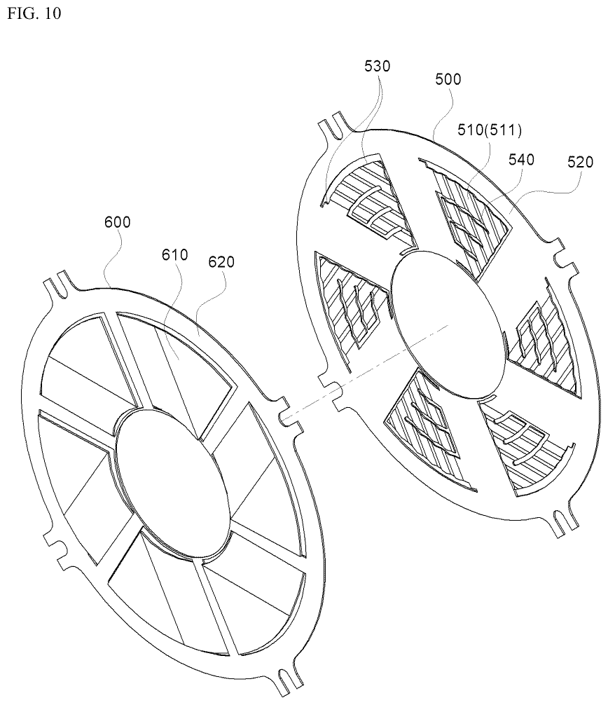

FIGS. 9 to 11 are an assembled perspective view, an exploded perspective view, and a top plan view illustrating an air foil thrust bearing according to a second embodiment of the present invention.

As illustrated, the air foil thrust bearing according to the second embodiment of the present invention may broadly include a bump foil plate 500 and a top foil plate 600.

The bump foil plate 500 may include a plurality of bump foils 510 and a first connection part 520. The plurality of bump foils 510 may be integrally coupled to the first connection part 520. The plurality of bump foils 510 may be arranged to be spaced apart from one another in the circumferential direction. One circumferential end of each of the plurality of bump foils 510 may be connected to the first connection part 520, and the other circumferential end of each of the plurality of bump foils 510 may be configured as a free end. Further, the remaining portion of each of the plurality of bump foils 510, except for one circumferential end connected to the first connection part 520, may be spaced apart from the first connection part 520. That is, only one circumferential end of each of the bump foils 510 may be connected to the first connection part 520, and radially inner and outer ends and the other circumferential end of each of the bump foils 510 may be spaced apart from the first connection part 520 without being connected to the first connection part 520. In addition, the plurality of bump foils 510 may have elastic bumps 511 having a concave-convex shape such that the plurality of bump foils 510 may be formed in a corrugated or wavy shape. The bump foil 510 may be formed in a shape in which the elastic bumps 511 protrude upward from an upper surface of the first connection part 520. In addition, the plurality of bump foils 510 may each have slits 540 formed through two opposite surfaces of the bump foil 510 in the thickness direction. The slit 540 may be formed in various shapes.

The top foil plate 600 may include a plurality of top foils 610 and a second connection part 620. The plurality of top foils 610 may be integrally connected to the second connection part 620. The plurality of top foils 610 may be arranged to be spaced apart from one another in the circumferential direction. One circumferential end of each of the plurality of top foils 610 may be connected to the second connection part 620, and the other circumferential end of each of the plurality of top foils 610 may be configured as a free end. Further, the remaining portion of each of the plurality of top foils 610, except for one circumferential end connected to the second connection part 620, may be spaced apart from the second connection part 620. That is, only one circumferential end of each of the top foils 610 may be connected to the second connection part 620, and radially inner and outer ends and the other circumferential end of each of the top foils 610 may be spaced apart from the second connection part 620 without being connected to the second connection part 620. In addition, the top foil 610 may be formed in a shape in which the top foil 610 protrudes upward from an upper surface of the second connection part 620 in the circumferential direction from the portion connected to the second connection part 620 toward the free end.

Further, the top foil plate 600 is stacked on the bump foil plate 500 so that the top foils 610 of the top foil plate 600 are positioned at positions corresponding to the bump foils 510 of the bump foil plate 500, thereby constituting a single foil thrust bearing. In this case, an outer diameter of the top foil 610 may be larger than an outer diameter of the bump foil 510 in the radial direction. That is, the outer diameter of the bump foil 510 may be smaller than the outer diameter of the top foil 610. For example, an outer diameter side of the bump foil 510 may have a cut-out portion 530 formed in a shape made by removing a partial region of the bump foil 510. Therefore, the outer diameter side of the top foil 610 in the radial direction may have a shape extending over the outer diameter side of the bump foil 510. The outer diameter side of the top foil 610, which corresponds to an outer region of the cut-out portion 530 of the bump foil 510 in the radial direction, may not be supported by the elastic bump 511 of the bump foil 510.

Therefore, as in the first embodiment, in the air foil thrust bearing according to the second embodiment of the present invention, friction with the rotating thrust runner in the outermost peripheral region of the top foil based on the radial direction is reduced, which may prevent the degradation of a coating layer applied onto a surface of the top foil, and as a result, the durability of the air foil thrust bearing may be improved. Further, the pressure of the air in the region supported by the bump foil is relatively uniformly dispersed, which may improve a load supporting force of the air foil thrust bearing.

In addition, as in the first embodiment, in the air foil thrust bearing according to the second embodiment of the present invention, an inner diameter of the top foil 610 and an inner diameter of the bump foil 510 may be equal to each other in the radial direction. Further, another foil may not be additionally interposed between the bump foil 510 and the top foil 610.

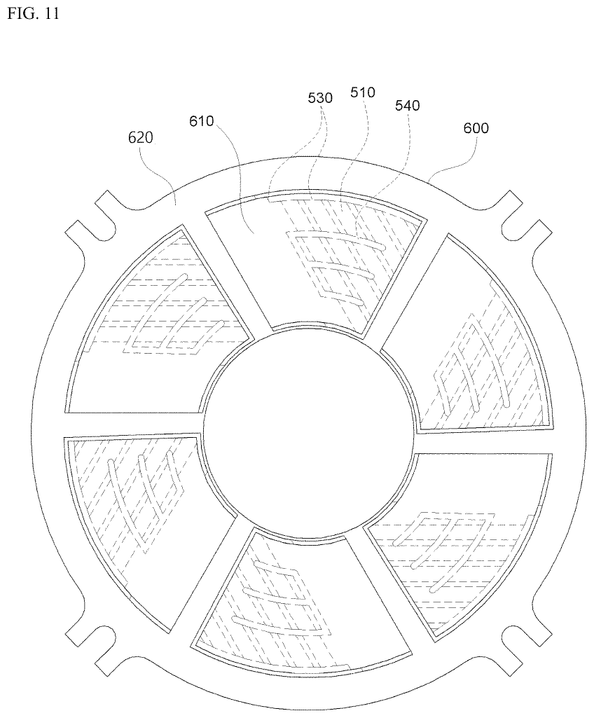

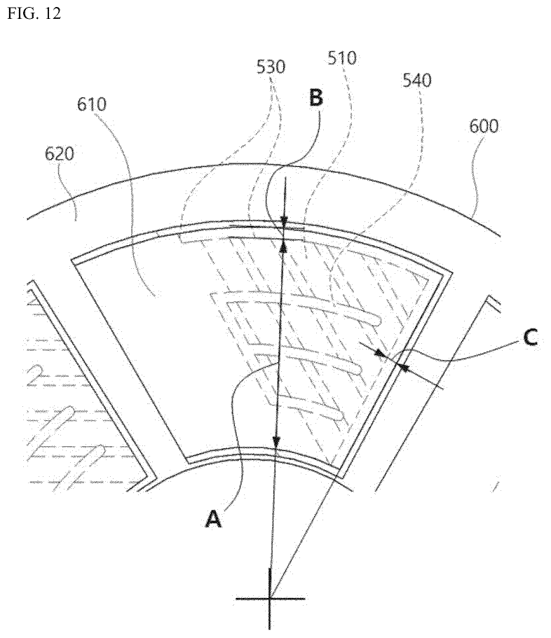

FIG. 12 is a partially enlarged view of FIG. 11.

As illustrated, the air foil thrust bearing may be formed such that B is within a range larger than 0% of A and equal to or smaller than 15% of A when A is ½ of a difference between the outer diameter of the bump foil 510 and the inner diameter of the bump foil 510 and B is ½ of a difference between the outer diameter of the top foil 610 and the outer diameter of the bump foil 510. In addition, one circumferential end of the bump foil 510 may be connected to the first connection part 520, and the other end of the bump foil 510 may be configured as a free end. One circumferential end of the top foil 610 may be connected to the second connection part 620, and the other end of the top foil 610 may be configured as a free end. The other end of the top foil 610 may be longer than the other end of the bump foil 510 in the circumferential direction, and C may be within a range larger than 0% of A and equal to or smaller than 15% of A when C is a difference in length between the other circumferential end of the top foil 610 and the other circumferential end of the bump foil 510. Therefore, the air foil thrust bearing according to the second embodiment of the present invention may also obtain the same effect as the first embodiment.

In addition, the bump foils 510 may be provided as a plurality of bump foils 510, and the top foils 610 may be provided as a plurality of top foils 610. The plurality of bump foils 510 and the plurality of top foils 610 may be arranged to be spaced apart from one another in the circumferential direction. The number of bump foils 510, the number of top foils 610, and the intervals between the bump foils 510 and the top foils 610 spaced apart from one another may be variously defined.

In addition, coupling parts may be respectively formed at a radially outer side of the first connection part 520 of the bump foil plate 500 and a radially outer side of the second connection part 620 of the top foil plate 600 and positioned at positions corresponding to each other in order to be coupled to a bearing housing and to fix positions thereof. In this case, the coupling part may be portions extending outward from the outer diameter of the first connection part 520 and the outer diameter of the second connection part 620.

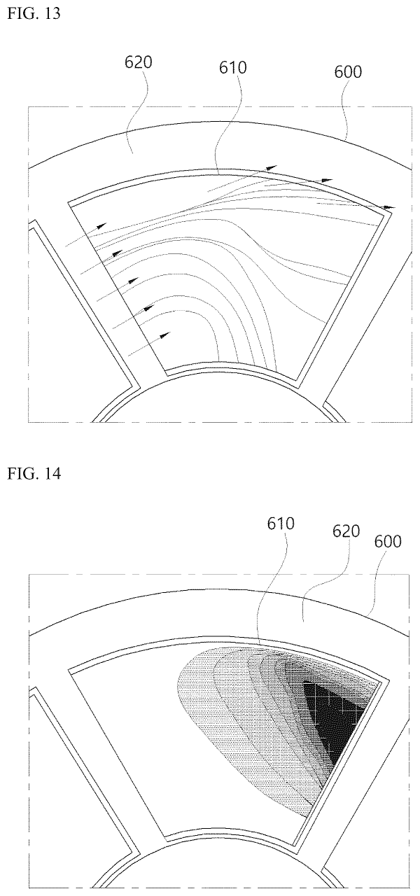

FIGS. 13 and 14 are a conceptual view of a pressure distribution of air and a conceptual view illustrating a flow line (stream line) of air flowing between the top foil and the thrust runner when the thrust runner of the air foil thrust bearing according to the second embodiment of the present invention rotates.

The pressure of the air film decreases when the air leaks radially outward because of a centrifugal force from the outermost periphery of the top foil based on the radial direction of the air foil thrust bearing. Therefore, as illustrated, in the present invention, the bump foil and the top foil are formed and disposed so that the portion where the pressure of the air film is relatively high is consistent with the region in which the bump foil exists, which reduces friction in the outermost peripheral region of the top foil based on the radial direction and relatively uniformly disperses the pressure of the air, thereby improving the load supporting force.

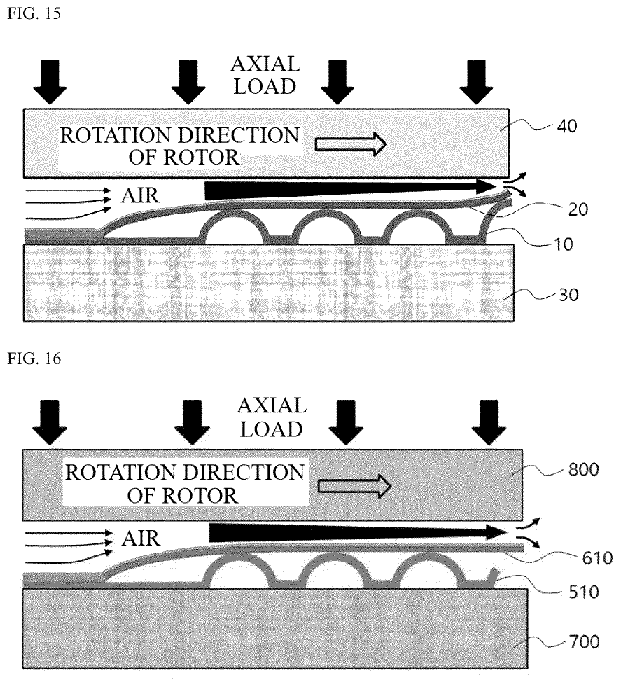

FIG. 15 is a conceptual view illustrating a cross-section when the air foil thrust bearing in the related art is cut to be inclined in a rotation direction of a rotor radially outward with respect to a radial direction, and FIG. 16 is a conceptual view illustrating a cross-section when the air foil thrust bearing according to the present invention is cut to be inclined in a rotation direction of a rotor radially outward with respect to a radial direction.

As illustrated in FIG. 15, an air foil thrust bearing in the related art is configured such that outer diameter side ends of a bump foil 10 and a top foil 20 are consistent with each other in the radial direction in the state in which the bump foil 10 and the top foil 20 are mounted in a bearing housing 30. In this case, when a rotor rotates, air leaks outward from the outer diameter side end of the top foil 20, and the pressure of the air decreases. For this reason, a force for pushing the outer diameter side end of the top foil 20 decreases, and the outer diameter side of the top foil 20 is slightly raised upward. For this reason, friction between the rotating rotor (thrust runner) 40 and the top foil 20 increases. In contrast, as illustrated in FIG. 16, in a state in which the air foil thrust bearing of the present invention is mounted in a bearing housing 700, an outer diameter side end of the top foil 610 extends outward from the bump foil 510 in the radial direction. In this case, when a rotor rotates, air leaks outward from the outer diameter side end of the top foil 610, and the pressure of the air decreases. However, because the bump foil 510 is not present below the outer diameter side of the top foil 610, the outer diameter side of the top foil 610 may be kept in a horizontal state without being raised upward. Therefore, the friction in the outermost peripheral region of the top foil may be reduced, and the pressure of the air may be relatively uniformly dispersed, thereby improving the ability to support the load.

The present invention is not limited to the above embodiments, and the scope of application is diverse. Of course, various modifications and implementations made by any person skilled in the art to which the present invention pertains without departing from the subject matter of the present invention claimed in the claims.

### DESCRIPTION OF REFERENCE NUMERALS

100: Base plate, 200: Bump foil, 210: Elastic bump,
220: Cut-out portion, 230: Slit, 300: Top foil,
500: Bump foil plate, 510: Bump foil,
511: Elastic bump, 520: First connection part, 530: Cut-out portion,
540: Slit, 600: Top foil plate, 610: Top foil,
620: Second connection part, 700: Bearing housing,
800: Rotor (thrust runner)

1. An air foil thrust bearing comprising:
a base plate;
a bump foil having elastic bumps and stacked and coupled onto the base plate; and
a top foil stacked at a position corresponding to the bump foil to cover the bump foil, the top foil being coupled to the base plate,
wherein an outer diameter of the top foil is larger than an outer diameter of the bump foil in a radial direction.

2. The air foil thrust bearing of claim 1, wherein a cut-out portion, which is formed in a shape made by removing a partial region of the bump foil, is formed at an outer diameter side of the bump foil.

3. The air foil thrust bearing of claim 1, wherein an inner diameter of the top foil and an inner diameter of the bump foil are consistent with each other in the radial direction.

4. The air foil thrust bearing of claim 1, wherein no additional foil is interposed between the bump foil and the top foil.

5. The air foil thrust bearing of claim 1, wherein B is within a range larger than 0% of A and equal to or smaller than 15% of A when A is ½ of a difference between an outer diameter of the bump foil and an inner diameter of the bump foil and B is ½ of a difference between an outer diameter of the top foil and the outer diameter of the bump foil.

6. The air foil thrust bearing of claim 5, wherein one circumferential end of each of the bump foil and the top foil is fixed to the base plate, and the other end of each of the bump foil and the top foil is configured as a free end,
wherein the other end of the top foil is longer than the other end of the bump foil in a circumferential direction, and
wherein C is within a range larger than 0% of A and equal to or smaller than 15% of A when C is a difference in length between the other end of the top foil and the other end of the bump foil.

7. The air foil thrust bearing of claim 1, wherein the bump foil is provided as a plurality of bump foils, the top foil is provided as a plurality of top foils, and the plurality of bump foils and the plurality of top foils are arranged to be spaced apart from one another in a circumferential direction.

8. The air foil thrust bearing of claim 1, wherein the bump foil has a slit formed through two opposite surfaces of the bump foil in a thickness direction.

9. An air foil thrust bearing comprising:
a bump foil plate in which a bump foil having elastic bumps is integrally coupled to a first connection part; and
a top foil plate in which a top foil is integrally coupled to a second connection part, the top foil plate being stacked on the bump foil plate so that the top foil is disposed at a position corresponding to the bump foil, wherein an outer diameter of the top foil is larger than an outer diameter of the bump foil in a radial direction.

10. The air foil thrust bearing of claim 9, wherein a cut-out portion, which is formed in a shape made by removing a partial region of the bump foil, is formed at an outer diameter side of the bump foil.

11. The air foil thrust bearing of claim 9, wherein an inner diameter of the top foil and an inner diameter of the bump foil are consistent with each other in the radial direction.

12. The air foil thrust bearing of claim 9, wherein no additional foil is interposed between the bump foil and the top foil.

13. The air foil thrust bearing of claim 9, wherein B is within a range larger than 0% of A and equal to or smaller than 15% of A when A is ½ of a difference between an outer diameter of the bump foil and an inner diameter of the bump foil and B is ½ of a difference between an outer diameter of the top foil and the outer diameter of the bump foil.

14. The air foil thrust bearing of claim 13, wherein the bump foil has one circumferential end connected to the first connection part, and the other end configured as a free end,
wherein the top foil has one circumferential end connected to the second connection part, and the other end configured as a free end,
wherein the other end of the top foil is longer than the other end of the bump foil in a circumferential direction, and
wherein C is within a range larger than 0% of A and equal to or smaller than 15% of A when C is a difference in length between the other end of the top foil and the other end of the bump foil.

15. The air foil thrust bearing of claim 9, wherein the bump foil is provided as a plurality of bump foils, the top foil is provided as a plurality of top foils, and the plurality of bump foils and the plurality of top foils are arranged to be spaced apart from one another in a circumferential direction.

16. The air foil thrust bearing of claim 9, wherein the bump foil has a slit formed through two opposite surfaces of the bump foil in a thickness direction.
